(19) United States
(12) Patent Application Publication
(10) Pub. No.: US 2026/0273795 A1
(43) Pub. Date: Sep. 17, 2026

(54) FIRE SHAVER

(71) Applicant: Outdoor Element, LLC, Englewood, CO (US)

(72) Inventor: Michael John Mojica, Englewood, CO (US)

(73) Assignee: Outdoor Element, LLC, Englewood, CO (US)

(21) Appl. No.: 19/181,091

(22) Filed: Apr. 16, 2025

Related U.S. Application Data
(60) Provisional application No. 63/634,770, filed on Apr. 16, 2024.

(51) Int. Cl. B27L 11/02; B43L 23/08; F23Q 1/06

(52) U.S. Cl. CPC B27L 11/02; F23Q 1/06; B43L 23/08

(57) ABSTRACT

A fire shaver including a shaver assembly, a striker, and a spark rod. The shaver assembly is configured to produce tinder and includes a blade and an opening to receive shaving items. The striker may be stored either externally on the fire shaver or internally within it and is configured to produce a spark when stricken against the spark rod. The fire shaver may include a center cavity section to mate and store components.

### CROSS-REFERENCE TO RELATED APPLICATIONS

This patent application claims priority of U.S. Provisional Patent Application No. 63/634,770, entitled “FIRE SHAVER,” filed Apr. 16, 2024, which is hereby incorporated by reference in its entirety.

### FIELD OF THE DISCLOSURE

The present disclosure relates to portable fire-starting devices.

### BACKGROUND

Fire-starting tools are essential components of survival kits, outdoor gear, and emergency preparedness systems. Traditional fire-starting devices often require separate components such as a knife, a ferrocerium rod, and suitable tinder material. These elements may be bulky, disorganized, or challenging to operate efficiently under adverse environmental conditions.

Conventional devices do not integrate all fire-starting functions in a compact form. Furthermore, the process of generating fire tinder from natural materials like twigs or branches can be laborious and unreliable, especially without a dedicated shaving mechanism.

Accordingly, there is a need for an integrated fire-starting device that combines tinder preparation, spark generation, and optional storage in a single, compact, and user-friendly assembly suitable for outdoor and survival scenarios.

### SUMMARY

Various aspects of this disclosure relate to a fire shaver.

In some embodiments, the fire shaver may include a shaver assembly. The shaver assembly may include a shaver and a striker plate.

In some embodiments, the shaver assembly may include a shaver, a striker plate, and a clip.

In some embodiments, the fire shaver may include a shaver assembly and a spark rod.

In some embodiments, the fire shaver may include a shaver assembly, a center cavity section, and a spark rod.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various implementations as further illustrated in the accompanying drawings and defined in the appended claims.

These and various other features and advantages will be apparent from a reading of the following Detailed Description.

### BRIEF DESCRIPTION OF THE DRAWINGS

The preferred and other embodiments are disclosed in association with the accompanying drawings in which:

FIG. 1 illustrates a perspective view of a fire shaver in accordance with aspects of the present disclosure.

FIG. 2 illustrates a perspective view of a fire shaver and a shaving item in accordance with aspects of the present disclosure.

FIG. 3 illustrates an exploded view of a fire shaver in accordance with aspects of the present disclosure.

FIG. 4 illustrates an exploded view of a fire shaver in accordance with aspects of the present disclosure.

FIG. 5A illustrates a shaving item within a shaver assembly to produce tinder.

FIG. 5B illustrates a shaver assembly unattached from a spark rod.

FIG. 6 illustrates an isometric view of an embodiment of a fire shaver with a lanyard.

FIG. 7 illustrates an isometric view of an embodiment of a fire shaver with a lanyard.

FIG. 8 illustrates a sectional view of an embodiment of a fire shaver with an internal scraper.

FIG. 9 illustrates a perspective view of an embodiment of a fire shaver with an internal scraper removed.

FIG. 10 is a flowchart of a method of use of an embodiment of a fire shaver.

FIG. 11 is a flowchart of method of manufacturing an embodiment of a fire shaver.

### DETAILED DESCRIPTION

In the following description, for the purposes of explanation, numerous specific details are set forth to provide a thorough understanding of the present invention. It will be apparent, however, to one skilled in the art that the present invention may be practiced without some of these specific details. For example, while various features are ascribed to particular implementations, it should be appreciated that the features described with respect to one implementation may be incorporated with some other implementations as well. Similarly, however, no single feature or features of any described implementation should be considered essential to the invention as some implementations of the invention may omit such features.

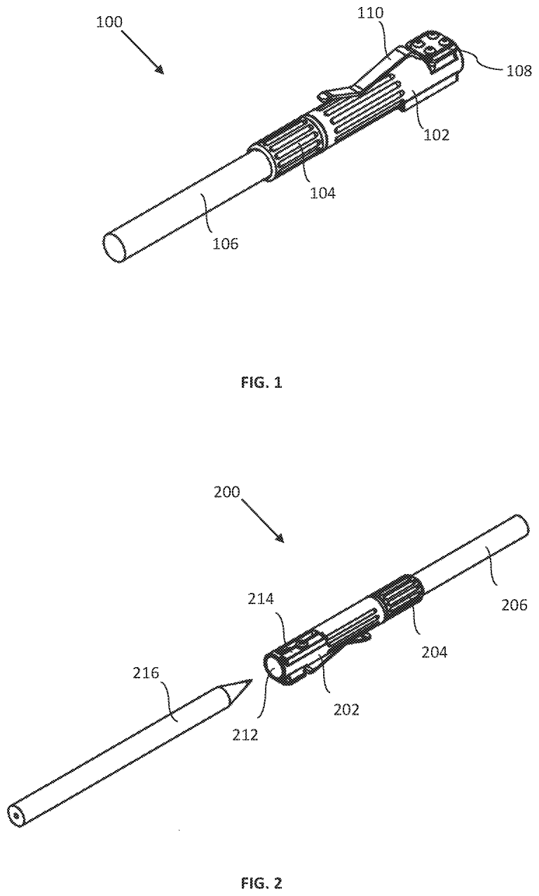

FIG. 1 illustrates an isometric perspective view of an embodiment of a fire shaver 100 in accordance with aspects of the present disclosure. In the embodiment of FIG. 1, the fire shaver 100 includes a shaver assembly 102, a center cavity section 104, and a spark rod 106.

The shaver assembly 102 may include a striker plate (e.g., striker, scraper) 108. The striker plate 108 is made of a material such that the plate may be scraped against the spark rod to produce sparks. For example, the striker plate 108 may be made with a hardened material like steel or ceramic. The striker plate 108 may be mounted relative (e.g., under or over) a clip 110. The striker plate 108 may extend beyond the mounting of the clip 110 to allow exposure of the striker plate 108 for striking. The clip 110 may be made of material the same or similar to the striker plate 108 such that the clip 110 may be used to strike the spark rod 106 to produce sparks.

The center cavity 104 may be used to mate the spark rod 106 and the shaver assembly 102. The center cavity 104 may be used as a multifunctional storage space. The storage volume of the center cavity 104 may be designed to hold fire-starting materials such as wax-infused wood chips, cotton balls, char cloth, or compressed tinder pellets. Alternatively, the center cavity 104 may store small survival items, including water purification tablets, matches, fishhooks, or first-aid items. The center cavity 104 may be waterproof. The exterior surface of the center cavity 104 may include texturing, grooves, or over molded grip materials (e.g., rubber or thermoplastic elastomer) to assist with handling in wet or gloved conditions. In some embodiments (discussed later), the center cavity acts as storage for an internal scraper. In some embodiments, the center cavity 104 is not included and the spark rod 106 and the shaver assembly 102 are mated directly to each other.

The spark rod 106 may be made of ferrocerium or any other material suitable for producing sparks, such as such as magnesium, mischmetal, or rare-earth composite rods. In the embodiment of FIG. 1, the spark rod 106 is round, but the rod may take other suitable shapes such as hexagonal, square, triangular, etc. The spark rod 106 may be threaded for attaching to other aspects of the present disclosure. The spark rod 106 may incorporate surface texturing, flattened striking planes, or integrated guide rails to assist in controlled scraping. The spark rod may include visual indicators or wear marks to inform users of remaining lifespan or optimal striking zones. The spark rod 106 and striker plate 108 may also be enclosed within a protective sleeve or sheath when not in use. The sheath may be integrated into the body of the fire shaver or may be an accessory that clips or threads into place.

FIG. 2 illustrates an isometric perspective view of an embodiment of a fire shaver 200 and a shaving item 216 in accordance with aspects of the present disclosure. In the embodiment of FIG. 2, the fire shaver 200 includes a shaver assembly 202, a center cavity section 204, and a spark rod 206.

The shaver assembly 202 may include an opening 212. The opening 212 may be used to insert a shaving item 216. The shaving item 216 can be a pencil, a twig, a branch, or the like to produce a fire tinder. In the illustrated embodiment, the shaving item 216 is a pencil and the opening 212 is concentric.

The shaver assembly may include a shaver 214. The shaver 214 may be a cutting blade such that, when the shaving item 216 is inserted into the opening 212 and rotated, or otherwise moved, the result is a shaving. In some embodiments, the opening 212 may include depth-stop features, such as an internal ridge, mechanical stop, or adjustable collar, that limit the insertion distance of the shaving item. This prevents over-penetration and enables controlled shaving length, which can be important for producing tinder of a consistent size or preparing pencils to a repeatable point. The shaver 214 may have rounded corners or a variety of shapes. The shaver 214 may be configured such that when the shaving item 216 is a pencil, the result of shaving will be a sharpened pencil.

In some embodiments, the shaver 214 may be formed with alternative blade geometries to optimize performance for different materials. The shaver may be straight-edged, serrated, concave, or V-shaped to accommodate various shaving techniques. A serrated blade may increase surface area contact for fibrous materials, while a concave or V-shaped blade may aid in centering and guiding cylindrical items during rotation.

FIG. 3 illustrates an isometric exploded view of a fire shaver 300. In the embodiment of FIG. 3, the fire shaver 300 includes a shaver assembly 302, a center cavity section 304, and a spark rod 306.

The shaver assembly 302 of the embodiment of FIG. 3 includes a striker plate 308, a clip 310, a shaver 314, and one or more screws 318. The screws 318 may be used to hold the shaver 314, the clip 310, and the striker plate 308 to the shaver assembly 302. An adhesive may be used in place of screws 318. The shaver assembly 302 may include an internal or female thread to receive the center cavity section 304 or the spark rod 306. The shaver assembly 302 may be mated with the center cavity section 304 or the spark rod 306 by other suitable means.

The shaver 314 may be mounted to the shaver assembly 302 using different fastening methods. In addition to screws 318, the shaver 314 may be retained by rivets, press-fit pins, sliding tracks, or recessed grooves that allow for user replacement or repositioning. In some embodiments, magnetic attachment mechanisms may allow for tool-free blade replacement or modular use with multiple blade types. In some implementations, the shaver 314 may be adjustable to modify cutting depth or angle relative to the shaving item. For example, a rotating collar, slidable housing, or threaded dial may allow the user to reposition the shaver for finer or coarser tinder output. Adjustable blade angles may accommodate user preferences or be tailored for different materials such as pencils, twigs, or bark.

The center cavity section 304 of the embodiment of FIG. 3 includes one internal or female thread to mate the spark rod 306 and one external or male thread to mate the shaver assembly 302. Once mated with the shaver assembly 302, the center cavity section 304 may form a watertight pocket. O-ring 320 may be included in some embodiments of the fire shaver 300 to produce a watertight seal.

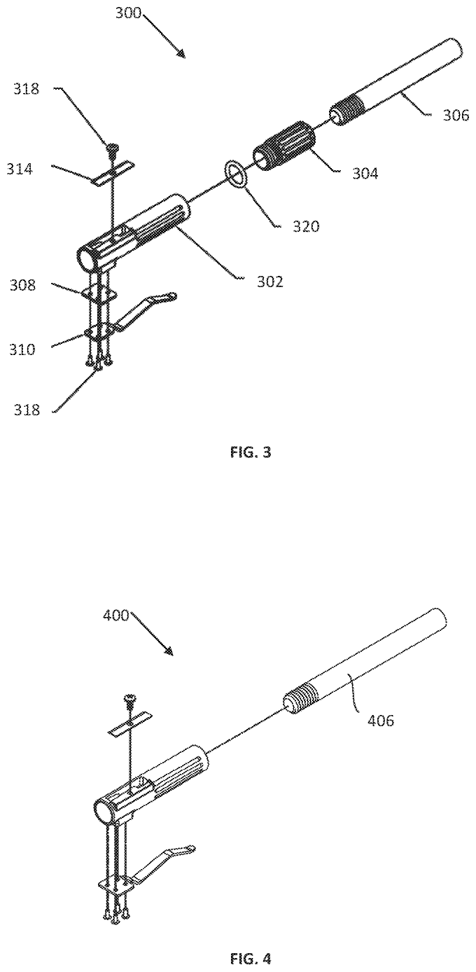

FIG. 4 illustrates an isometric exploded view of a fire shaver 400. In the embodiment of FIG. 4, the fire shaver 400 includes a shaver assembly 402 and a spark rod 406. In this embodiment of a fire shaver, there is no center cavity section-the shaver assembly 402, with an internal or female thread, is mated directly to the spark rod 406, with an external or male thread.

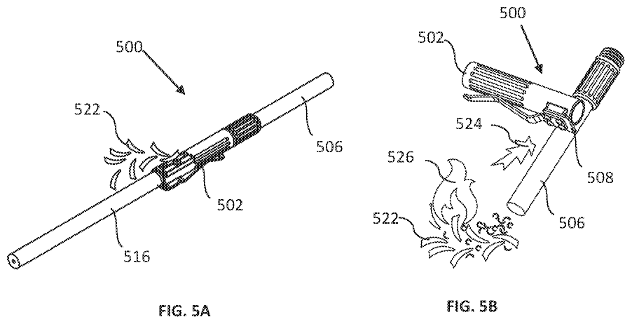

FIG. 5A illustrates a shaving item 516 that is inserted and moved within the shaver assembly 502 to produce tinder 522. The shaver assembly 502 is made such that the tinder 522 produced by shaving the shaving item 516 is effective for starting a fire.

FIG. 5B illustrates a shaver assembly 502 unattached from the spark rod 506. The striker plate 508 is stricken on the spark rod 506 to produce a spark 524. Once the spark 524 meets the tinder 522, a flame 526 is produced. Other sources may be used to ignite the tinder 522. For example, a lighter or match may be used to light tinder 522 and produce flame 526.

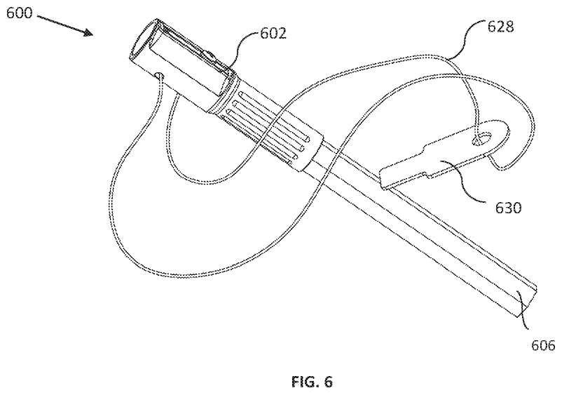

FIG. 6 illustrates an isometric view of an embodiment of a fire shaver 600 with a lanyard 628. The shaver assembly 602 includes attachment means to connect the lanyard 630. The lanyard includes a scraper (e.g., striker) 630 used to strike the spark rod 606 to produce a spark. The scraper may be made with a hardened material like steel or ceramic, or any other suitable material for producing a spark. The lanyard 628 may be used as an attachment means, such that the fire shaver can be worn around a user's neck, tied to a backpack, or hung on a tree branch, for example. The cord used to form the lanyard may be formed with a multipurpose material, such as paracord, polyester, static cord, nylon, etc. Reflective traces may be incorporated into the lanyard to enhance nighttime visibility.

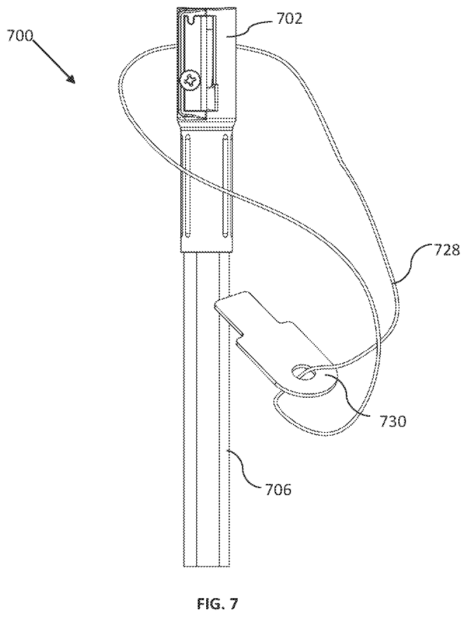

FIG. 7 illustrates an isometric view of an embodiment of a fire shaver 700 with a lanyard 728. The shaver assembly 702 includes attachment means to connect the lanyard 728. The lanyard includes a scraper 730 used to strike the spark rod 706 to produce a spark. In some embodiments, the lanyard 628 may incorporate detachable or quick-release mechanisms (not shown) to allow safe and rapid removal of the fire shaver from the user's body or gear. Examples include side-release buckles, magnetic breakaway clasps, or cam-lock connectors. These features are useful when the device is worn around the neck or attached to gear and must be removed quickly in an emergency.

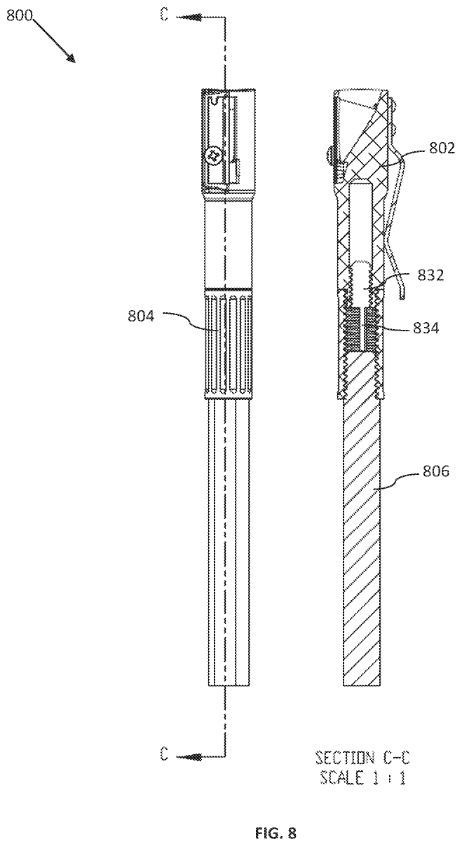

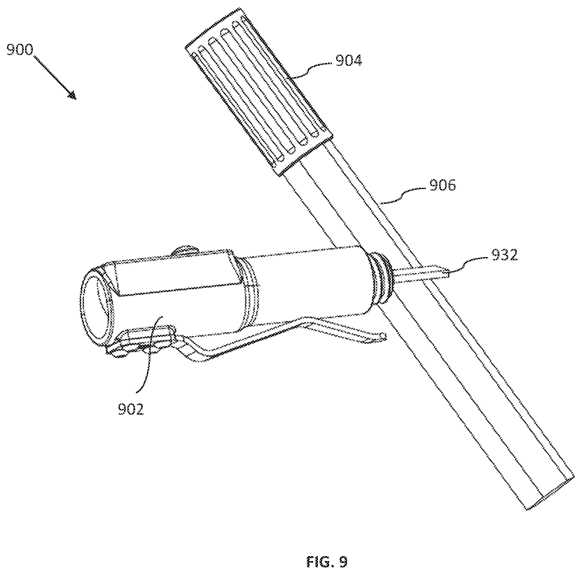

FIG. 8 illustrates a sectional view of an embodiment of a fire shaver 800 with an internal scraper 832. In the illustrated embodiment, the fire shaver 800 includes a shaver assembly 802, a center cavity section 804, and a spark rod 806. The center cavity sections includes a hollow interior cavity 834 configured to receive and store an internal scraper 832. In some embodiments, the interior cavity may be formed directly inside the spark rod section. The internal scraper 832 may be made of a hardened material such as steel or ceramic and may be dimensioned to fit securely within the interior cavity 834 during transport or storage.

In the stored position, internal scraper 832 is retained within the cavity 834, which may include threading, friction fit, detents, or magnetic elements to hold the scraper in place. This configuration allows the fire shaver 800 to provide integrated storage of the scraper while preserving a streamlined form factor. The internal scraper 832 may be removed from cavity 834 for use in generating sparks, as further shown in FIG. 9.

FIG. 9 illustrates a perspective view of an embodiment of a fire shaver 900 with an internal scraper 932 removed. In the illustrated embodiment, the internal scraper 932 has been removed from the center cavity 904 and is shown striking the ferrocerium surface of the spark rod 906 to generate sparks.

The internal scraper 932 may include a straight edge, beveled edge, or texturing optimized for producing high-temperature sparks upon contact with the ferro rod. During use, the user may grip the shaver assembly 902 and draw it along the length of the spark rod 906 to initiate ignition of tinder. After use, the internal scraper 932 may be reinserted into the center cavity 904 for compact storage. This embodiment enhances user convenience by eliminating the need for an externally mounted or lanyard-attached scraper, while maintaining secure access to the striker when needed.

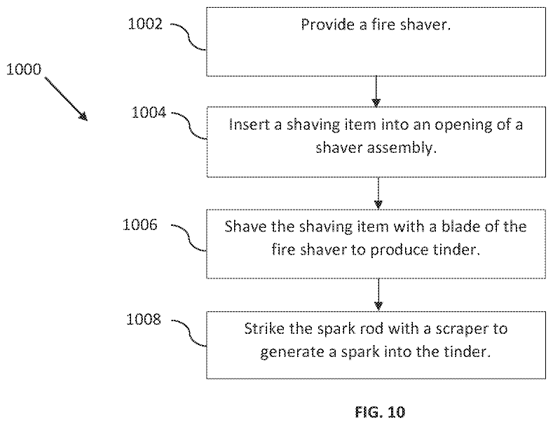

FIG. 10 illustrates a method of use of an embodiment of the fire shaver 1000. In the method of use, a fire shaver 1002 is produced to provide both a means for generating tinder and a source of ignition. At 1004, the user selects a suitable shaving item, such as a pencil, twig, or other flammable stick-shaped material, and inserts it into the shaver opening located on the shaver assembly. At 1006, the user then rotates or scrapes the shaving item against the internal blade to generate fine shavings or curls, which serve as tinder. The tinder produced from this shaving process may be collected directly beneath the shaver or transferred to a designated ignition site, such as a fire pit or base of a kindling structure. At 1008, the user may ignite the tinder using the integrated spark rod. The user detaches the scraper from its storage location —for example, from a lanyard or from within an internal cavity —and strikes it along the length of the spark rod (e.g., ferrocerium rod) to produce sparks. The user directs the sparks toward the collected tinder until ignition occurs. Once ignited, the tinder produces a flame suitable for lighting larger kindling or other fuel sources. After ignition, the scraper may be returned to its storage location.

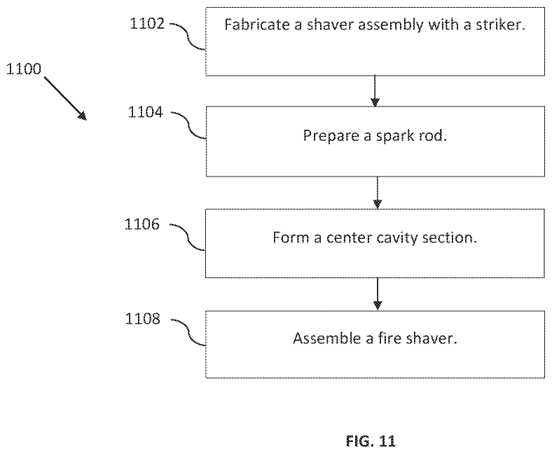

FIG. 11 illustrates a method of manufacturing an embodiment of the fire shaver 1100. At 1102, the shaver assembly may be fabricated by cutting, casting, or otherwise shaping a housing from a material, such as aluminum, titanium, steel, or zinc. The housing may be machined or die-cast. An opening is formed in the housing, such as by milling, drilling, or mold shaping, the opening being configured to receive and guide a shaving item (e.g., pencil, twig). The opening may be circular, hexagonal, or conical and may optionally include depth stops or guide ridges. A shaver blade is positioned in the opening, oriented such that material from the shaving item is removed when rotated or pulled through the opening. The blade may be formed by stamping and ground to a razor edge. The blade may be mounted via, for example, press-fit, mechanical fasteners, adhesive, or embedded in a molded slot. In some embodiments, a striker plate may also be attached to the exterior of the shaver assembly. The striker plate may be formed from a hardened material, such as steel or ceramic, and may be affixed using screws, rivets, or adhesive. The striker plate may be configured to extend from or be flush with the assembly body to facilitate spark generation when used with a ferrocerium rod. An internal scraper may be attached to the shaver assembly such that it can be removably stored within the center cavity section or within a cavity of the spark rod. A lanyard with a scraper may be integrated with the shaver assembly.

At 1104, the spark rod is prepared. In some embodiments, the spark rod is prepared via casting the ferrocerium to a desired shape. In some embodiments, it is prepared by cutting a ferrocerium rod, or other suitable material, to a desired length. The spark rod is then prepared via machining of external threads or other coupling features that allow the spark rod to engage with either the center cavity section or the shaver assembly directly. The rod may include surface treatments or features such as flattened striking planes or wear indicators. In some configurations, a hollow bore may be included within the rod to house an internal scraper or accessory.

At 1106, in embodiments including a center cavity section, the center cavity is machined or cast to function as an intermediate coupler between the shaver assembly and the spark rod. This section includes internal threads, external threads, or other mechanical engagement features. The outer wall of the center cavity may be textured, knurled, or contoured to enhance grip. Surface treatments may be applied, such as anodization, powder coating, or vacuum-deposited coatings such as Physical Vapor Deposition (PVD). In some embodiments, the interior of the center cavity may be configured to receive an internal scraper, to function as a storage chamber, and can be sealed via an O-ring or compression seal when assembled.

At 1108, the shaver assembly, spark rod, and optional center cavity section are assembled into an embodiment of the fire shaver. Threading or other fastening methods are used to mate the components. The scraper—whether externally mounted or stored internally —is integrated into the device if not done in a previous step.

The above specification, examples, and data provide a complete description of the structure and use of exemplary implementations of the invention. Since many implementations of the invention can be made without departing from the spirit and scope of the invention, the invention resides in the claims hereinafter appended. Furthermore, structural features of the different implementations may be combined in yet another implementation without departing from the recited claims. While embodiments and applications of this invention have been shown, and described, it would be apparent to those skilled in the art having the benefit of this disclosure that many more modifications than mentioned above are possible without departing from the inventive concepts herein. The invention, therefore, is not to be restricted except in the spirit of the appended claims.

The embodiments of the disclosure are drafted such that various different embodiments may be combined as set forth, for example, in the multiple dependency of the claims that follow. Every combination of embodiments that is grammatically, mathematically, and logically consistent is contemplated. The skilled person may identify one or more combinations of embodiments that are unfeasible, and the existence of any such unfeasible combination shall not limit any combination of embodiments that the skilled person would identify as feasible in light of this disclosure.

The methods described in this disclosure include examples of implementations, and the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for consumer preference.

The description set forth herein describes example configurations and does not represent all the examples that may be implemented or that are within the scope of the claims. The detailed description includes specific details for the purpose of providing an understanding of the described techniques. These techniques, however, may be practiced without these specific details.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A fire shaver, comprising:
a shaver assembly configured to produce tinder including:
a blade and an opening;
a striker; and
a spark rod.

2. The fire shaver of claim 1, further comprising a center cavity section.

3. The fire shaver of claim 2, wherein the striker is stored internally and removably within the center cavity section.

4. The fire shaver of claim 2, wherein the center cavity section is a storage area.

5. The fire shaver of claim 1, wherein the striker is integrated externally onto the shaver assembly.

6. The fire shaver of claim 5, wherein a pocket clip is attached to the striker on the shaver assembly.

7. The fire shaver of claim 1, further comprising a sheath.

8. The fire shaver of claim 1, wherein the blade is replaceable.

9. The fire shaver of claim 1, wherein the striker is attached to a lanyard.

10. A method of manufacturing a fire shaver, comprising:
fabricating a shaver assembly with a striker;
preparing a spark rod; and
assembling the shaver assembly and the spark rod.

11. The method of claim 10, wherein the shaver assembly and the spark rod include compatible threads and assembling the shaver assembly and the spark rod includes threading the shaver assembly and the spark rod together.

12. The method of claim 10, wherein fabricating the shaver assembly comprises:
fabricating a housing;
forming an opening in the housing;
positioning a blade in the opening of the housing; and
attaching the striker to the housing.

13. The method of claim 10, wherein preparing the spark rod comprises:
casting ferrocerium to a desired shape; and
machining threads.

14. The method of claim 10, further comprising forming a center cavity section.

15. The method of claim 14, wherein forming a center cavity section includes:
fabricating the center cavity section to function as an intermediary between the shaver assembly and the spark rod; and
surface treating the center cavity section.

16. The method of claim 14, wherein the center cavity section is configured to internally receive the striker.

17. A method of using a fire shaver, including:
providing the fire shaver;
inserting a shaving item into an opening of a shaver assembly of the fire shaver;
shaving the shaving item with a blade of the shaver assembly;
producing tinder responsive to shaving the shaving item;
striking a spark rod of the fire shaver with a scraper; and
generating a spark into the tinder responsive to striking the spark rod.

18. The method of claim 17, further comprising:
returning the scraper to a storage location of the fire shaver.

19. The method of claim 17, further comprising:
igniting the tinder responsive to generating the spark into the tinder.

20. The method of claim 17, wherein the shaving item is a pencil or a twig.
